(19) United States
(12) Patent Application Publication
(10) Pub. No.: US 2004/0095974 A1
(43) Pub. Date: May 20, 2004

(54) Vapor cycle system (VCS) with thermal reservoirs for reducing requisite VCS power and size with intermittent heat loads

(75) Inventor: Richard A. Gibson, Torrance, CA (US)

Correspondence Address: DiPinto & Shimokaji, P.C., 1301 Dove Street, Suite 480, Newport Beach, CA, 92660, US

(73) Assignee: Honeywell International Inc., Morristown, NJ (US)

(21) Appl. No.: 10/295,191

(22) Filed: Nov. 14, 2002

(51) Int. Cl. H01S 3/04; F25B 1/00; F25B 39/04

(52) U.S. Cl. 372/35; 62/498; 62/506

(57) ABSTRACT

A system for providing coolant to a heat load includes a first coolant reservoir providing coolant to the heat load and a second coolant reservoir receiving used coolant after passing through the heat load. The used coolant is refreshed by a cooling apparatus which receives the used coolant from the second coolant reservoir, cools the used coolant, and supplies refreshed coolant to said first coolant reservoir. The resulting dual reservoir system offers significant reductions in the size, weight and power of the vapor cycle system (VCS) equipment while providing for accurate temperature control of the coolant delivered to the heat load.

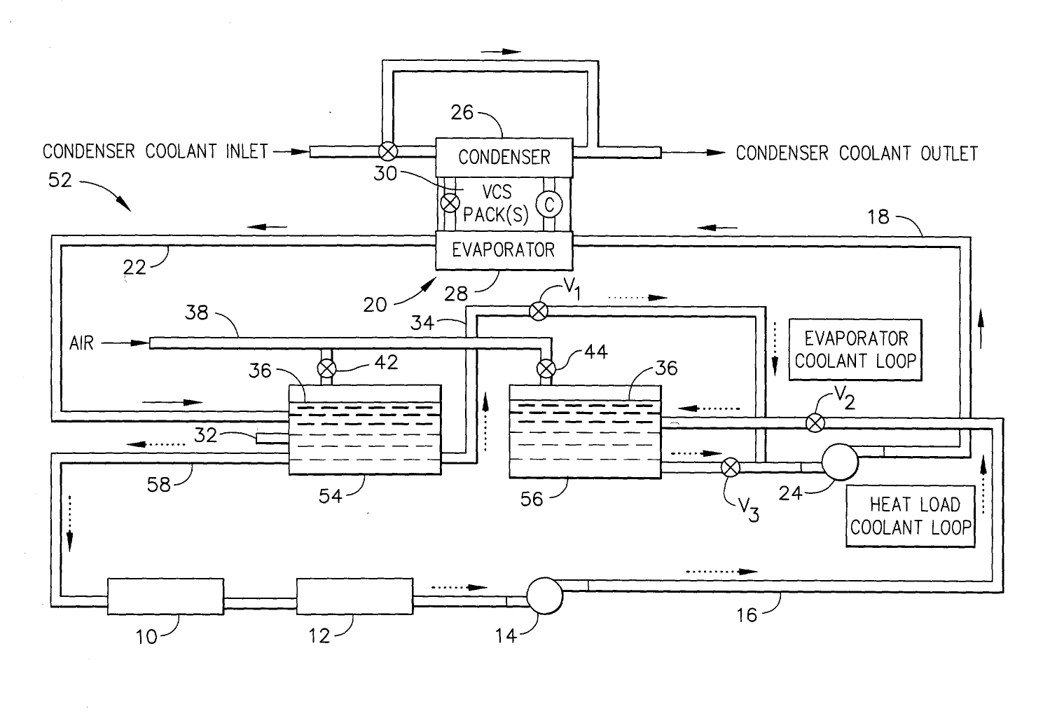

### BACKGROUND OF THE INVENTION

The present invention relates generally to a coolant providing system having thermal reservoirs for reducing the requisite system power and size, and, more specifically, to a vapor cycle system (VCS) which provides apparatus and methods for providing a coolant to a heat load. The present invention is especially beneficial for applications having intermittent heat loads which require a high degree of accurate temperature control.

Solid state lasers are known to use various cooling devices to prevent a thermal overload. In many applications, solid state lasers require a precisely controlled inlet coolant temperature. A high power solid state laser could potentially require in excess of 100 tons instantaneous cooling during laser firing. A conventional system would require significant space and weight consumption while also being extremely power intensive.

U.S. Pat. No. 5,608,748 discloses a cooling liquid flowing from a reservoir, through the laser cavity, and back to the reservoir. The coolant is chilled within the reservoir with a cooling element. Precision cooling, however, is difficult, as the spent coolant is returned to the reservoir and mixed with the supply coolant. A large reservoir and/or a high power cooling element is required to approach the achievement of a suitable precision thermal control.

U.S. Pat. No. 4,850,201 discloses a cooling liquid flowing from a reservoir, through the heat load (such as an industrial laser machine or an injection molding machine for plastic), and back to the reservoir. The disclosure describes controlling overcooling of the coolant by optionally removing a portion of the coolant from the loop and warming the liquid in a heat exchanger until the overcooling situation is corrected. In order to maintain precision thermal control, especially when used for intermittent high heat loads, a large reservoir and high cooling power is required.

As can be seen, there is a need for an improved apparatus and method for a cooling system that provides precision thermally controlled coolant to a heat load. Furthermore, there exists a need to provide such a cooling system which is neither reliant upon an extraordinarily large coolant reservoir nor a large power supply.

### SUMMARY OF THE INVENTION

In one aspect of the present invention, a system for providing coolant to a heat load comprises a first coolant reservoir providing coolant to the heat load; a second coolant reservoir receiving used coolant after passing through the heat load; and a cooling means for receiving the used coolant from the second coolant reservoir, cooling the used coolant, and supplying coolant to the first coolant reservoir.

In another aspect of the present invention, a method for providing coolant to a heat load comprises providing a first coolant reservoir and a second coolant reservoir; chilling coolant in the first coolant reservoir to provide a usable coolant; passing the usable coolant from the first coolant reservoir through the heat load to the second coolant reservoir, the usable coolant becoming used coolant after passing through the heat load; and passing the used coolant from the second coolant reservoir, through a cooling means, back to the first coolant reservoir, the used coolant becoming usable coolant after passing through the cooling means.

In another aspect of the present invention, a vapor cycle system for cooling a laser heat load comprises a first coolant reservoir; a second coolant reservoir; a heat load coolant loop circulating coolant from the first coolant reservoir, to the laser heat load, and returning used coolant to the second coolant reservoir; a cooling means; and an evaporator coolant loop circulating used coolant from the second coolant reservoir, through the cooling means, cooling the coolant, and supplying coolant to the first coolant reservoir.

In another aspect of the present invention, a vapor cycle system for cooling a laser heat load comprises a first water reservoir for storing coolant chilled to a predetermined temperature; a second water reservoir for receiving used coolant; a heat load coolant loop communicating the first water reservoir with the laser heat load, and the laser heat load with the second water reservoir; a first pump circulating coolant through the laser heat load in the heat load coolant loop; cooling means, the cooling means having a condenser, an evaporator, and at least one VCS pack; an evaporator coolant loop communicating the second water reservoir with the cooling means, and the cooling means with the first water reservoir; a second pump circulating coolant through the cooling means in the evaporator coolant loop, whereby the used coolant is chilled to the predetermined temperature and returned to the first water reservoir.

These and other features, aspects and advantages of the present invention will become better understood with reference to the following drawings, description and claims.

### BRIEF DESCRIPTION OF THE DRAWINGS

The FIGURE is a schematic diagram showing the VCS of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

In general, the present invention is a coolant providing system having at least two thermal reservoirs. More particularly, the present invention relates to a vapor cycle system having a cold coolant reservoir and a hot coolant reservoir. Additionally, the present invention provides a method for providing a coolant to a heat load. The present invention is especially beneficial for applications having intermittent heat loads, such as solid state lasers, which require a high degree of accurate temperature control. In these cases the Vapor Cycle System Pack can be sized for the average heat load rather than the instantaneous heat load, resulting in a significant reduction in the size and weight of the Vapor Cycle System Pack. The lower the duty cycle of the heat load the greater the reduction in the size and weight of the pack.

In conventional vapor cycle cooling systems, using a circulating liquid as the coolant, precision cooling, especially for intermittent high heat loads, is inadequate. Moreover, such conventional systems require a large coolant reservoir, require a high power cooling element, and/or have a considerable mass occupying a large volume.

Referring to the FIGURE, a VCS system 52 may have a cold water reservoir 54 and a hot water reservoir 56. Cold water reservoir 54 and hot water reservoir 56 may be thermally insulated reservoirs, thereby permitting minimal heat exchange between the stored coolant water and the environment. A cold water output line 58 may bring cold water from cold water reservoir 54 to a heat load. In one embodiment of the present invention, the heat load may include a first laser heat load 10 and a second laser heat load 12. A first pump 14 may carry the used coolant, via a hot water reservoir input line 16, to hot water reservoir 56. A valve V₂ may control the flow of coolant through this heat load water loop as shown by the dotted-lined arrows.

The coolant in hot water reservoir 56 may be driven, via a second pump 24, through a hot water reservoir output line 18, through cooling system 20, returning to cold water reservoir 54 via a cold water reservoir input line 22. Cooling system 20 may include a condenser 26, an evaporator 28, and a sufficient number of VCS packs 30 to provide for the average (not instantaneous) heat removal requirements. A valve V₃ may control the flow of coolant through this evaporator water loop as shown by the solid arrows.

A temperature sensor 32 may be provided in cold water reservoir 54 for monitoring the coolant temperature and precisely controlling the inlet coolant to the correct temperature via a controls loop (not shown). A cooldown loop output line 34 circulates the coolant, via hot water reservoir output line 18, through cooling system 20 as necessary to maintain the desired coolant output temperature. A valve V₁ may be provided in cooldown loop output line 34 to appropriately regulate the flow of coolant through cooldown loop output line 34.

A diaphragm 36 may be provided within each of cold water reservoir 54 and hot water reservoir 56. Air contained within the coolant significantly limits the heat capacity of the coolant. Diaphragm 36 is designed to limit the amount of air contained in the coolant by isolating the coolant from the air at the head of the coolant reservoirs. Preferably, air is delivered via air pressure line 38 to supply adequate pressure from diaphragm 36 onto the surface of the coolant in the reservoirs.

In one alternate embodiment of the present invention, at least one of pumps 14 and 24 may be removed. Pressure on the coolant via diaphragms 36 would then be used to move the coolant through VCS system 52. Coolant pressure may be adjusted appropriately by regulating valves 42 and 44.

### EXAMPLE

Referring still to the FIGURE, one embodiment of the present invention, uses VCS system 52 to provide precise thermal control to a first laser heat load 10 and a second laser heat load 12. First laser heat load 10 requires a coolant controlled input temperature of approximately 40° F. The coolant output from first laser heat load 10 is fed to second laser heat load 12.

Initially, the cold water reservoir 54 is filled with about 170 lbs of ambient temperature water. While less water may be used in this example, excess water is preferred so that there is no chance of the system running dry. In this “cool down” operating condition, valve V₁ is opened and pump 24 feeds the ambient temperature water through cooldown loop output line 34, hot water reservoir output line 18, and cooling system 20. The output coolant, having the precisely controlled inlet temperature, returns to cold water reservoir 54 via cold water reservoir input line 22. Preferably, water flows through the system during this initial cool down phase at a flow rate of X lbm/sec, where X is a flow capable of achieving the desired cooling effect. When temperature sensor 32 detects the cold water reservoir coolant temperature to be controlled to the desired temperature, the VCS system 52 is operational and ready to cool a heat load.

During the “heat load on” stage, valve V₁ is closed. Suppose the duty cycle (ratio of laser on-time to total cycle time) is 33 percent. Valve V₂ is opened and pump 14 feeds the coolant water, at a flow rate of 3X lbm/sec, from cold water reservoir 54 into first laser heat load 10 at the requisite controlled input temperature. The output coolant from first laser heat load 10, is fed into second laser heat load 12. The output coolant from second laser heat load 12, flows, via hot water reservoir input line 16 to hot water reservoir 56.

At the same time, valve V₃ is opened and pump 24 feeds warm coolant from hot water reservoir 56 through hot water reservoir output line 18 and cooling system 20 to return chilled water, via cold water reservoir input line 22, to cold water reservoir 54. This evaporator water loop circulates at a flow rate of X lbm/sec. Thus, water is removed from cold water reservoir 54 at a net rate of 2X lbm/sec and water is added to hot water reservoir at a net rate of 2X lbm/sec. At the end of, say, a four second laser firing cycle, cold water reservoir 54 contains 170-8X lbm of water and hot water reservoir 56 contains 8X lbm of high temperature water.

During the “heat load off” stage, valve V₂ is closed and warm coolant is removed from hot water reservoir 56 at a flow rate of X lbm/sec. The warm coolant is fed from hot water reservoir 56 through hot water reservoir output line 18 and cooling system 20 to return water, via cold water reservoir input line 22, to cold water reservoir 54. At the end of the cycle, hot water reservoir 56 contains no water and cold water reservoir 54 contains 170 lbs. of water. The water in cold water reservoir 54 is ready to act as coolant for another laser firing sequence.

The table below summarized the above operations:

| | | | Heat Load | Evaporator |
|---|---|---|---|---|
| | | | Water Loop | Water Loop |
| Operating | Valve | Pump | Flow | Flow |
| Condition | Positions | Operations | (lbm/sec) | (lbm/sec) |
| Cool Down | V₁ open | | | |
| | V₂ closed | Pump 24 on | 0.0 | X |
| | V₃ closed | Pump 14 off | | |
| Heat Load On | V₁ closed | | | |
| | V₂ open | Pump 24 on | 3X | X |
| | V₃ open | Pump 14 on | | |
| Heat Load Off | V₁ closed | | | |
| | V₂ closed | Pump 24 on | 0.0 | X |
| | V₃ open | Pump 14 off | | |

In the above example, the average heat load requirements using the VCS system of the present invention, having water in a cold and hot reservoir for thermal storage and precise temperature control, is about one-third of the requisite instantaneous heat load at the laser.

In the above example, water is used as the coolant. The present invention is not limited to water, as any conventional coolant may be used so long as it does not effect the operation of the heat load. When a laser is the heat load, water or a water/alcohol mixture is preferred. In a laser system, a coolant that has a different index of refraction may result in undesired effects to the laser pulse. However, in other systems, such as cooling systems for mission control avionics or wing-embedded sensors, any coolant may be used. For example, polyalphaolefin (PAO) is useful for its good dielectric properties as well as its low freezing point.

The number of VCS packs required to cool the water is a function of the time interval between laser firings (off time) and the heat removal capacity of the VCS Pack. The longer the off time, the lower the average heat load and the fewer required VCS packs. Alternatively, the water reservoir weight penalty can be reduced by using a larger capacity VCS Pack.

Further variations are within the scope of the present invention. For example, the heat load may be any heat source in need of cooling wherein cooling can be effected through a flowing liquid coolant. For example, the heat load may be an aviation-related heat load, such as mission control avionics or wing-embedded sensors. Other machines requiring cooling, such as injection molding machines, may also benefit from the VCS system of the present invention. The cooling system is not limited to using VCS packs, and may be any cooling means capable of cooling a flowing liquid coolant.

The above example describes a VCS system using one cold water reservoir and one hot water reservoir. However, the present invention is not intended to be limited to such an embodiment. Any number of cold water reservoirs and any number of hot water reservoirs may prove useful in a VCS system of the present invention, depending on the desired functionality. For example, a plurality of cold and hot water reservoirs may be employed to create the most efficient use of available space and tubing.

The above example describes a VCS system for cooling a first and a second laser heat load in series. However, the present invention is not intended to be limited to such an embodiment. Any number of head loads, either in series or in parallel, may be cooled by the cooling system of the present invention.

The vapor cycle system of the present invention, having cold and hot thermal reservoirs, offers significant reductions in the size, weight and power of the VCS equipment while providing for accurate temperature control of the coolant delivered to the heat load. The cold water reservoir stores thermally controlled coolant, having it immediately available for a heat load. The hot water reservoir receives the used coolant, allowing the coolant to pass through the coolant cooling means before being returned to the cold water reservoir. Such a system is especially useful in systems having a high intermittent heat load, such as high powered solid state lasers.

It should be understood, of course, that the foregoing relates to preferred embodiments of the invention and that modifications may be made without departing from the spirit and scope of the invention as set forth in the following claims.

We claim:

1. A system for providing coolant to a heat load comprising:
a first coolant reservoir providing coolant to said heat load;
a second coolant reservoir receiving used coolant after passing through said heat load; and
cooling means;
said cooling means receiving said used coolant from said second coolant reservoir, cooling said used coolant, and supplying coolant to said first coolant reservoir.

2. The system according to claim 1, wherein said heat load comprises at least one laser heat load.

3. The system according to claim 2, wherein said heat load comprises a first laser heat load in series with a second laser heat load.

4. The system according to claim 1 further comprising:
a diaphragm covering an air/coolant boundary within each of said first coolant reservoir and said second coolant reservoir; and
pressurizing means for supplying a force on said air/coolant boundary, whereby as a coolant level in said reservoirs is changed, said diaphragm remains at said air/coolant boundary.

5. The system according to claim 4, wherein said pressurizing means comprises pressurized air delivered onto a diaphragm surface opposite to a diaphragm surface covering said air/coolant boundary.

6. The system according to claim 1, further comprising:
a temperature sensor in said first coolant reservoir monitoring a temperature of said coolant in said first coolant reservoir;
reservoir coolant cooling means for cooling coolant in said first coolant reservoir when said temperature sensor measures a coolant temperature greater than a predetermined desired coolant temperature.

7. The system according to claim 6, wherein said reservoir coolant cooling means includes:
a cooldown loop output line, communicating coolant between said first coolant reservoir and said cooling means; and
a first coolant reservoir input line, communicating coolant at said predetermined desired coolant temperature between said cooling means and said first coolant reservoir.

8. The system according to claim 1, wherein said cooling means includes a condenser, an evaporator, and at least one VCS pack.

9. The system according to claim 1, wherein said coolant is a liquid coolant.

10. A method for providing coolant to a heat load comprising:
providing a first coolant reservoir and a second coolant reservoir;
chilling coolant in said first coolant reservoir to provide a usable coolant;
passing said usable coolant from said first coolant reservoir through said heat load to said second coolant reservoir, said usable coolant becoming used coolant after passing through said heat load; and
passing said used coolant from said second coolant reservoir, through a cooling means, back to said first coolant reservoir, said used coolant becoming usable coolant after passing through said cooling means.

11. The method according to claim 10, wherein said heat load comprises at least one laser heat load.

12. The method according to claim 11, wherein said heat load comprises a first laser heat load in series with a second laser heat load.

13. The method according to claim 10 further comprising:
covering an air/coolant boundary within each of said first coolant reservoir and said second coolant reservoir with a diaphragm; and
supplying a force on said air/coolant boundary, whereby as a coolant level in said reservoirs is changed, said diaphragm remains at said air/coolant boundary.

14. The method according to claim 10, wherein said cooling means includes a condenser, an evaporator, and at least one VCS pack.

15. The method according to claim 10, wherein said coolant is a liquid coolant.

16. A vapor cycle system for cooling a laser heat load comprising:
a first coolant reservoir;
a second coolant reservoir;
a heat load coolant loop circulating coolant from said first coolant reservoir, to said laser heat load, and returning used coolant to said second coolant reservoir;
cooling means; and
an evaporator coolant loop circulating used coolant from said second coolant reservoir, through said cooling means, cooling said coolant, and supplying coolant to said first coolant reservoir.

17. The vapor cycle system according to claim 16, wherein said heat load comprises a first laser heat load in series with a second laser heat load.

18. The vapor cycle system according to claim 16, further comprising:
a diaphragm covering an air/coolant boundary within each of said first coolant reservoir and said second coolant reservoir; and
pressurizing means for supplying a force on said air/coolant boundary, whereby as a coolant level in said reservoirs is changed, said diaphragm remains at said air/coolant boundary, said pressurizing means comprises pressurized air delivered onto a diaphragm surface opposite to a diaphragm surface covering said air/coolant boundary.

19. The system according to claim 16, further comprising:
a temperature sensor in said first coolant reservoir monitoring a temperature of said coolant in said first coolant reservoir;
reservoir coolant cooling means for cooling coolant in said first coolant reservoir when said temperature sensor measures a coolant temperature greater than a predetermined desired coolant temperature.

20. The system according to claim 19, wherein said reservoir coolant cooling means includes:
a cooldown loop output line, communicating coolant between said first coolant reservoir and said cooling means; and
a first coolant reservoir input line, communicating coolant at said predetermined desired coolant temperature between said cooling means and said first coolant reservoir.

21. The system according to claim 16, wherein said cooling means includes a condenser, an evaporator, and at least one VCS pack.

22. The system according to claim 16, wherein said coolant is a liquid coolant.

23. A vapor cycle system for cooling a laser heat load comprising:
a first water reservoir for storing coolant chilled to a predetermined temperature;
a second water reservoir for receiving used coolant;
a heat load coolant loop communicating said first water reservoir with said laser heat load, and said laser heat load with said second water reservoir;
a first pump circulating coolant through said laser heat load in said heat load coolant loop;
cooling means, said cooling means having a condenser, an evaporator, and at least one VCS pack;
an evaporator coolant loop communicating said second water reservoir with said cooling means, and said cooling means with said first water reservoir;
a second pump circulating coolant through said cooling means in said evaporator coolant loop, whereby said used coolant is chilled to said predetermined temperature and returned to said first water reservoir.

24. The vapor cycle system according to claim 23 wherein said laser heat load comprises at least a first laser heat load and a second laser heat load.

25. The vapor cycle system according to claim 23, further comprising:
a first reservoir cooldown loop communicating coolant between said first water reservoir and said cooling means, and between said cooling means and said first water reservoir;
a pump in said first reservoir cooldown loop for circulating said coolant;
first reservoir cooldown loop activating means for activating said first reservoir cooldown loop when a temperature of said coolant in said first coolant reservoir is above said predetermined temperature, whereby precision control of the coolant temperature in said first water reservoir is maintained.

26. The vapor cycle system according to claim 23, further comprising:
a diaphragm covering an air/coolant boundary within each of said first coolant reservoir and said second coolant reservoir; and
pressurizing means for supplying a force on said air/coolant boundary, whereby as a coolant level in said reservoirs is changed, said diaphragm remains at said air/coolant boundary, said pressurizing means comprises pressurized air delivered onto a diaphragm surface opposite to a diaphragm surface covering said air/coolant boundary.
